(19) United States
(12) Patent Application Publication
(10) Pub. No.: US 2009/0179718 A1
(43) Pub. Date: Jul. 16, 2009

(54) HIGH-POWERED SWITCHING DEVICE DISPOSED ON AN ELECTRICALLY POWERED VEHICLE

(75) Inventors: Christophe Aubigny, Sarniguet (FR); Nicolas Quentin, Ibos (FR)

Correspondence Address: SUGHRUE MION, PLLC, 2100 PENNSYLVANIA AVENUE, N.W., SUITE 800, WASHINGTON, DC, 20037, US

(73) Assignee: ALSTOM Transport SA, Levallois Perret (FR)

(21) Appl. No.: 12/353,027

(22) Filed: Jan. 13, 2009

(30) Foreign Application Priority Data
Jan. 15, 2008 (FR) 08 00234

(51) Int. Cl. H01H 51/27; B60L 5/00; H01H 9/32; H01H 15/06

(52) U.S. Cl. 335/126; 307/9.1; 200/10; 200/550

(57) ABSTRACT

Switching device (D) disposed on an electrically powered vehicle, able to switch, by rectilinear displacement of a contact means (52) by means of a drive means (60), indiscriminately in the two directions, between a first state in which the said contact means (52) establishes an electrical connection between a first individual terminal (I₁) and a common terminal (Co) and a second state in which the said contact means (52) establishes an electrical connection between a second individual terminal (I₂) and the said common terminal (Co), the said switching device (D) being characterised in that the said individual terminals (I₁, I₂), the said common terminal (Co) and the said contact means (52) are disposed within one single insulator (14).

### FIELD OF THE INVENTION

The invention relates to a high-powered switching device disposed on an electrically powered vehicle supplied by a supply line such as a catenary line or a rail, such as a railway vehicle or a trolleybus.

A vehicle with a multi-voltage supply is able to be supplied with electrical voltages collected on a direct current voltage line, for example a catenary line, (of which the voltage is for example 750 volts, 1500 volts or 3000 volts) or alternatively with electrical voltages collected on a monophase current catenary line (of which the voltage is for example 15000 volts at 16⅔ Hertz or even 25000 volts at 50 Hz).

A switch is understood to be a switching device capable of switching between a first state, in which a contact means establishes an electrical connection between a first individual terminal and a common terminal and a second state in which the said contact means establishes an electrical connection between a second individual terminal and the said common terminal by displacement of the said contact means by a drive means.

A switch is likewise capable of switching between the said second state and the said first state. However, for greater clarity, in the course of the description we will only mention the switching between the first state and the second state.

A high-powered switch is understood to mean a switch which is capable of producing switching between alternating current supply lines with a voltage of 15000 V or 25000 V with a current of 800 amperes or a direct current supply line with a voltage of 750 V to 3000 V with a direct current of 4500 A.

A switch is understood to mean a switching device of which the three terminals are electrically connected to a supply circuit.

A disconnecting switch is understood to mean a particular switching device in which only the common terminal and an individual terminal are connected to a supply circuit, wherein the third terminal is not connected to any supply circuit.

### PRIOR ART

A switch is known in which the switching between the first and the second state is achieved by the rectilinear displacement of the said contact means.

A device of this type is for example described in the patent application JP09200905.

In this device each of the terminals comprises a block pierced by a groove, the block being disposed in the air, at the top of an insulator. The three insulators supporting the three terminals are spaced in a longitudinal direction, and the two individual terminals are disposed on either side of the common terminal along a longitudinal direction. The common terminal and a first individual terminal rest on a first plate, the second individual terminal resting on a second support plate.

The contact means adapted to produce the electrical connections between the common terminal and the first individual terminal on the one hand and the common terminal and the second individual terminal on the other hand is a movable tubular bar comprising an electrically conductive part. The contact means produces the electrical connection between the common terminal and the first (second) individual terminal when the tubular bar, which is in a first (second) position, penetrates both into the groove of the common terminal and the groove of the first (second) individual terminal.

During the switching, the displacement of the tubular bar between its first and its second position is achieved by a drive means which extends beyond the space formed between the two individual terminals. The drive means consists of a lever which is disposed above and below the second support plate, the said lever being actuated by an actuator which is situated below this same support plate. The drive means and the actuator of such a device are bulky.

Moreover, in air two high-voltage terminals each connected to an alternating high-voltage line of 25 kV must be separated by a leakage line of which the minimum length is half a metre.

The term “leakage line” refers to the minimum distance which the current must travel by routing along an insulating body (insulator) in order to be propagated between the two conductive parts of the insulator.

Moreover, the distance, referred to as the insulation distance, between two terminals each connected to a 25 KV supply line must be greater than 230 millimetres in air.

These distances are regulated in Europe by the standard EN50124-1.

Such a switching device according to the prior art has the drawback that it occupies a large space and is difficult to install amongst the equipment of the vehicle.

Thus the object of the present invention is to propose a switch which occupies a reduced space and can be easily installed on a vehicle.

A further object of the invention is to propose an autonomous electrical unit capable of performing several electrical functions which can be easily installed on a vehicle.

### BRIEF DESCRIPTION OF THE INVENTION

The invention therefore relates to a switching device disposed on an electrically powered vehicle of the type mentioned above in which the said individual terminals, the said common terminal and the said contact means are disposed within one single insulator.

According to other embodiments, the switching device has one or several of the following characteristics, considered in isolation or in any technically possible combinations:
the said drive means is accommodated within the said insulator,
the insulator comprises a casing defining an internal space extending in a longitudinal direction; the first individual terminal, the second individual terminal and the contact means are spaced longitudinally in the longitudinal direction; the said contact means extends in the longitudinal direction between the first individual terminal and the second individual terminal; the said contact means is connected to the said common terminal by a connection means,
during the switching the contact means undergoes a translatory movement in the longitudinal direction in such a way as to be displaced, indiscriminately in the two directions, from a first position in which it establishes the electrical connection to the first individual terminal to a second position in which it establishes the electrical connection to the second individual terminal,
the internal space is sealed and is filled with a dielectric fluid,
the drive means comprises:
   at least two coils installed in the casing and each surrounding an individual terminal;
   permanent magnets distributed over the ends of the casing;
   a means for displacement of the contact means;
   the coils being supplied by means of a supply means disposed outside the insulator,
the said device is disposed on an electrically powered vehicle, on a support, in such a way that the longitudinal direction is substantially vertical,
the said device is disposed on a railway vehicle, on a support, in such a way that the longitudinal direction is substantially horizontal,
the said switching device is of the switch type, wherein the first individual terminal, the second individual terminal as well as the common terminal are each connected to a supply circuit,
the said switch is of the HOC switch type, in which:
   the first individual terminal is an earth terminal and is connected electrically to an earth line;
   the second individual terminal is a collection terminal and is connected electrically to a collection line;
   the common terminal is a power terminal and is connected to a DC power line,
the said switching device is of the disconnecting switch type, the common terminal as well as only one of the two individual terminals each being connected to a supply circuit,
the said switch is of the PbT or PbR switch type,
the terminals of the switching device which are connected to a supply line, with the exception of the terminal(s) which is/are connected to an earth line, are connected to connection points which are insulated from the support,

The invention also relates to a method of implementing a switching device, wherein the said switching device has at least any one of the preceding characteristics, in order to produce the switching between the said first state and the said second state, characterised in that it comprises:
a step of supplying current to the coils in a first current circulation direction in such a way as to drive the contact means in the direction of the second individual terminal;
a step of interruption of the supply of current to the coils when the contact means establishes the electrical connection with the second terminal in such a way as to keep the contact means in position by means of the permanent magnets.

According to other embodiments, the device for implementing the switching device has one or several of the following characteristics, considered in isolation or in any technically possible combinations:
the switching device comprises:
   a step of supplying current to the coils in a second current circulation direction in such a way as to drive the contact means in the direction of the first individual terminal;
   a step of interruption of the current supply to the coils when the contact means establishes the electrical connection to the first terminal in such a way as to keep the contact means in position by means of the permanent magnets,
the contact means is driven from the first individual terminal towards the second individual terminal when the longitudinal component of the magnetic field created by the current circulating in the coil is opposed to the longitudinal component of the magnetic field created by the permanent magnets, the said contact means then being driven towards the second individual terminal by means of a displacement device.

The invention also relates to an electrical unit, characterised in that it includes in an integrated manner on a single individual support:
a voltage current measuring device;
a switching device of the HOC type.

According to another embodiment, the said electrical unit further includes, in an integrated manner on the said single individual support, at least one unit selected from amongst:
an earthing switch;
a lightning arrester;
a monophase circuit breaker.

Other characteristics, objects and advantages of the invention will become apparent upon reading of the detailed description which follows, and with reference to the appended drawings, given by way of non-limiting examples and in which:

### BRIEF DESCRIPTION OF THE DRAWINGS

FIG. 1 shows a diagram of a conventional current collection circuit for a railway vehicle;

FIG. 2 shows schematically a sectional plane of a switching device according to the invention.

FIG. 3 shows schematically in a side view the integration in a roof of a switching device according to the invention, according to a first embodiment in which the switching device is a switch of the HOC type.

FIG. 4 shows schematically in a perspective view the integration in a roof of a switching device according to the invention, according to a first embodiment, in which the switching device is a disconnecting switch of the PbT type. FIG. 4 also shows a roof unit according to the invention.

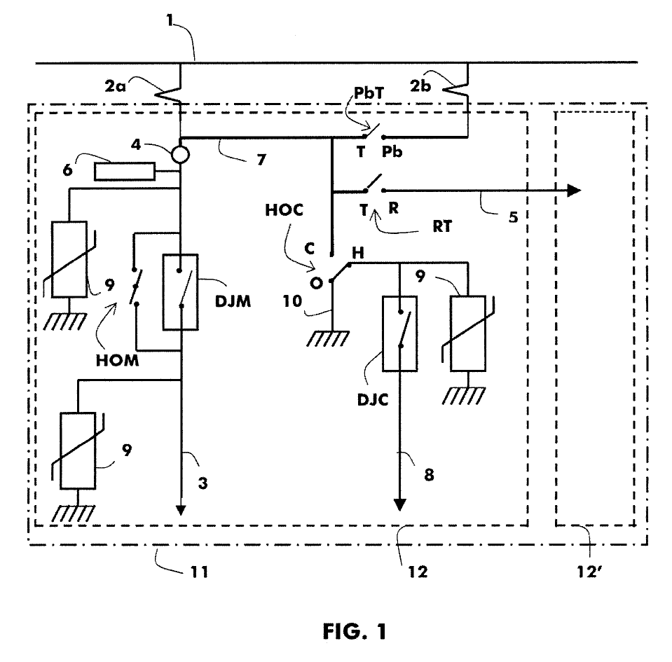

FIG. 1 shows a diagram of a conventional current collection circuit for a railway vehicle 11 comprising two carriages 12 and 12′.

The traction drive system of a railway vehicle with a multi-voltage traction circuit is conventionally supplied with a direct or alternating current collected on a supply line, in this case a catenary line 1, by means of two power collection devices, in this case a high-voltage pantograph 2a and a low-voltage pantograph 2b, in the roof of a carriage 12 of a railway vehicle 11.

As a variant, the supply line is an electric supply rail and the power collection means are for example contact shoes.

The low-voltage pantograph 2b is adapted to collect on the catenary line 1a direct current at a voltage of 1500 volts. The high-voltage pantograph 2a is adapted to collect on the catenary line 1 currents at a voltage greater than 1500V.

When the high-voltage pantograph 2a and low-voltage pantograph 2b come into contact with the catenary line 1, they are adapted to carry the power collected on the catenary line 1 between the catenary line 1 and the collection line 7, shown by solid lines in FIG. 1.

The railway vehicle 11 conventionally comprises switches capable of configuring the power collection circuit of the vehicle in such a way as to establish the necessary electrical connections between the units of the vehicle as a function of the supply voltage of the catenary line 1.

A switching device PbT which constitutes a disconnecting switch is in the supply circuit of the vehicle, on the collection line 7 between the high-voltage pantograph 2a and the low-voltage pantograph 2b.

A switching device TR which constitutes a disconnecting switch is disposed between the collection line 7 and an inter-body connection line 5.

The collection line 7 is connected to a monophase power line 3, on which are installed a voltage sensing means 4 and a current measuring means 6. The voltage sensing means 4 is adapted to recognise the voltage carried by a monophase power line 3.

The monophase power line 3 is adapted to route the electrical power from the collection line 7 towards a traction drive system of the railway vehicle (not shown) in such a way as to supply the traction drive system when the catenary line 1 carries an AC voltage.

In a manner which is known per se, a monophase circuit breaker DJM is disposed between the voltage sensing means 4 and the traction drive system on the monophase power line 3.

In a manner which is known per se, an earthing switch HOM is disposed in parallel with the monophase circuit breaker DJM.

A DC power line 8 is adapted to carry a direct current between the collection line 7 and the said traction drive system.

A continuous circuit breaker DJC is disposed on the DC power line 8 between a switch HOC and the said traction drive system. The continuous switch HOC comprises a collection terminal C connected to the collection line 7, a common power terminal H connected to the DC power line 8 and an earth terminal O connected to earth by means of an earth line 10. An earth line is a supply line which is connected to earth, that is to say to the vehicle 11. A unit disposed on a vehicle is connected to earth when it is electrically connected to the vehicle, for example to the roof, when the unit is disposed on the roof of the vehicle.

For example, an electrical unit which is disposed on the roof of a railway vehicle is connected to earth when it is connected to the roof 65 of the railway vehicle 11.

The continuous switch HOC is adapted to switch between a first state, in which the collection terminal C and a common power terminal H are electrically contacted in such a way as to electrically connect the DC power line 8 to the collection line 7, and a second state, in which the earth terminal O and a common power terminal H are physically and electrically contacted in such a way as to connect the DC power line 8 to earth.

In the switch HOC the terminal H is a terminal common to the two states of the switch, and the terminals O and C are respectively a first and a second individual terminals.

The disconnecting switch PbT comprises solely two terminals Pb and T connected to a supply circuit. More precisely, the terminal T is connected to the collection line 7, and the terminal Pb is connected to the low-voltage pantograph 2b.

The disconnecting switch PbT is adapted to switch between a first state in which the terminals Pb and T are contacted physically and electrically in such a way as to establish the electrical connection between the collection line 7 and the low-voltage pantograph 2b, and a second state in which the pantograph 2b is not connected electrically to any supply line.

The disconnecting switch TR comprises two terminals T and R. The terminal T is connected to the collection line 7 and the terminal R is connected to an inter-body collection line 5.

The disconnecting switch TR is adapted to switch between a first state, in which the terminals R and T are electrically contacted in such a way as to establish the electrical connection between the collection line 7 and the inter-body collection line 5, and a second state, in which the inter-body collection line 5 is no longer connected electrically to the collection line 7.

The inter-body connection line 5 is connected to a second current collection circuit disposed in a second carriage 12′ and adapted to carry supply current from one or several pantographs disposed on the second carriage 12′ towards a second traction drive system.

When one of the pantographs disposed on the second carriage 12′ is faulty, the second traction drive system can be supplied, via the pantographs 2a and 2b of the first vehicle 12, by connecting the inter-body connection line 5 to the collection line 7 via the switch TR. The switch TR is then in a first state in which the terminals T and R are connected.

When the second traction drive system is supplied by its own current collection circuit the switch TR is in a second state in which the terminal T and the terminal R are disconnected.

Lightning arresters 9 connect respectively the AC power line 3, the DC power line 8 and the collection line 7 to earth in such a way that the said lines are protected by absorption of energy from voltage surges and lightning.

When the vehicle 11 is a travelling on a line which can be supplied with several types of voltages, the driver sends to an on-board computer (not shown) information representing the supply voltage of the catenary line 1 on the section of track on which the vehicle 11 is located.

The on-board computer controls the contacting of an electricity collection device with the supply line, for example by raising the pantograph 2a or 2b corresponding to the said supply voltage.

The voltage sensing means 4 measure the supply voltage on the collection line 7. The on-board computer compares the voltage measured by the voltage sensing means 4 with the information sent by the driver to the on-board computer.

If these two values are identical the on-board computer configures the electrical power collection circuit device.

Configuring the circuit is understood to mean switching the switching devices of the power collection circuit. More particularly, the drive means displace the contact means in order to establish the electrical connections for supplying the traction drive system of the vehicle by means of the electrical power collected on the catenary line 1. The monophase circuit breaker DJM or continuous circuit breaker DJC is then closed in such a way as to supply the traction drive system.

For example, if the pantograph 2a is raised and the voltage carried by the catenary line 1 is an alternating voltage, the on-board computer controls the switching of the switch HOC in such a way as to disconnect the DC power line 8 from the collection line 7 and to connect the DC power line 8 to earth. The closure of the circuit breaker DJM is then controlled by the on-board computer. The circuit breaker DJC is open.

When the pantograph 2a is raised and the voltage carried by the catenary line is a DC voltage of 3 kV, the on-board computer controls the switching of the switch HOC in such a way as to connect the DC power line 8 to the collection line 7 in order to carry the electrical power from the catenary line towards the traction units via the DC power line 8. The closure of the circuit breaker DJC is then controlled by the on-board computer. The circuit breaker DJM remains open.

When the pantograph 2a is raised and the voltage carried by the catenary line is a DC voltage of 1.5 kV the on-board computer controls the lowering of the pantograph 2a and the raising of the pantograph 2b. The on-board computer controls the switching of the disconnecting switch PbT in such a way as to electrically connect the pantograph 2b to the collection line 7, in order to carry the electrical power from the low-voltage pantograph 2b towards the traction units of the vehicle.

The computer also controls the switching of the switch HOC in such a way as to connect the DC power line 8 to the collection line 7. The closure of the circuit breaker DJC is then controlled by the on-board computer. The circuit breaker DJM remains open.

The step of configuration of the circuit makes it possible to avoid the deterioration of the electrical units of the vehicle, which may result from the closure of the circuit breakers DJC or DJM, whilst the configuration of the circuit is not adapted to the power carried by the catenary line 1.

The on-board computer controls the switching of the respective switches and the disconnecting switches solely if the state of the electrical connections established by the switches and respectively the switches of the supply circuit is not adapted to the voltage carried by the catenary line 1.

When the pantograph of the second carriage 12′, which is adapted to collect the voltage from the catenary line, is faulty, the on-board computer controls the closure of the disconnecting switch RT in such a way as to connect the collection line 7 to the connection line 5 in order to ensure the supply of the second traction drive system by means of the supply circuit of the first vehicle.

The person skilled in the art will readily understand that a vehicle is equipped with one or several of the switches described above as a function of the types of supply disposed on the path of the vehicle and capable of supplying the vehicle and as a function of the functionalities which the vehicle should offer.

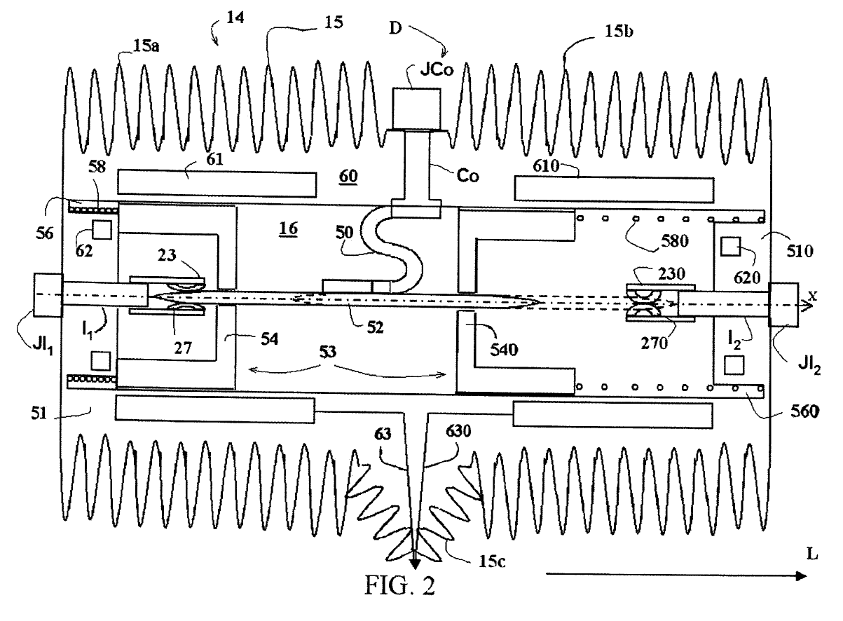

A description will now be given of a switching device according to the invention. As can be seen in FIG. 2, a switching device D according to the invention comprises an insulator 14 of generally cylindrical shape extending in a direction L, referred to as the longitudinal direction in the following description.

Any direction perpendicular to the longitudinal direction L will be referred to as the transverse direction.

The insulator 14 comprises a closed casing 15 defining a substantially tubular internal space 16. The space 16 extends in the longitudinal direction between two bases 51 and 510. The space 16 is rotationally symmetrical about an axis X extending parallel to the longitudinal direction L. In the embodiment shown in FIG. 2 the internal space 16 is substantially tubular.

The casing 15 is formed from an insulating material, for example ceramic, polymer resin, . . . . These materials have a good behaviour with regard to their environment.

The casing 15 comprises two rows of coaxial annular fins 15a and 15b distributed along the longitudinal axis L on either side of an electrically conductive junction bar JCo. The junction bar JCo is fixed to the casing 15 and is connected to the common terminal Co of the switch D. The common terminal Co is a metal terminal disposed within the insulator 14. The common terminal Co is disposed on the surface of the internal space 16.

The junction bar JCo is adapted to electrically connect the common terminal Co to a supply circuit of the vehicle 11.

The insulator 14 is for example a 25000 volt insulator having a leakage line of at least 0.5 metres. Thus the insulator has a length of approximately 0.5 metres.

The first individual terminal I₁ and the second individual terminal I₂ are spaced longitudinally in the direction L. More precisely, the first individual terminal I₁ and the second individual terminal I₂ are provided respectively on the first base 51 and on the second base 510.

The individual terminals I₁ and I₂ each have a first end connected to a junction bar JI₁, and JI₂ respectively, and a second end disposed within the internal space 16.

The junction bars JI₁ and JI₂ are formed from an electrically conductive material and are adapted to electrically connect the individual terminals I₁ and I₂ respectively to supply circuits of the railway vehicle 11.

The common terminal Co is connected electrically to a contact means 52 by means of an electrically conductive connection means 50 which is disposed in the internal space 16. The connection means is preferably a flexible connection means. The connection means 50 is for example a flexible braid.

The conductive bar 52 comprises two ends spaced longitudinally in the direction L between the two individual terminals I₁ and I₂. The length of the conductive bar 52 is less than the distance separating the two individual terminals I₁ and I₂.

The first end of the conductive bar 52 faces the individual terminal I₁ and the second end of the said conductive bar 52 faces the second individual terminal I₂. The conductive bar 52 is held in the direction L by means of a holding device 53 which will be described more precisely in the remainder of the description.

Within the internal space 16 the ends of the terminal I₁ and the terminal I₂ respectively are provided with tubular structures 23, and 230 respectively, of which the axis is parallel to the direction L in such a way as to form a jaw which opens facing the first end, and the second end, respectively of the tubular bar 52.

A pair of flexible strips 27, 270 respectively, is fixed on the internal surface of the tubular structure 23, 230 respectively.

In the embodiment shown in FIG. 2 the two strips of each pair of strips 27, 270 are disposed on either side of the longitudinal axis X and the contact means 52 extends along the axis X. The flexible strips of each pair 27, 270 respectively, are in contact with one another when the tubular structure 23, 230 respectively, is not penetrated by the contact means 52. When the contact means 52 penetrates into the tubular structure 23 it deforms the flexible strips 27 which rest on the contact means 52.

FIG. 2 shows in solid lines the position of the contact means 52 when the switching device D is in a first state in which the first individual terminal I₁ and the common terminal Co are electrically connected.

In this position the contact means 52 establishes the electrical connection between the first terminal I₁ and the common terminal Co by penetrating into the tubular structure 23 of the terminal I₁. In this position the contact means 52 is connected electrically to the first individual terminal I₁ by means of the flexible strips 27.

FIG. 2 shows in dotted lines the position occupied by the contact means 52 when the switching device is in the second state in which the second individual terminal I₂ and the common terminal Co are electrically connected.

In this second position the contact means 52 penetrates into the jaw formed by the tubular structure 230.

A holding and displacement device 53 is adapted to hold the contact means 52 in the longitudinal direction L along the axis X, whilst allowing the displacement of the contact means 52 along the axis X. The holding device 53 comprises two movable elements 54 and 540 which are disposed in the tubular space 16.

The movable elements 54, 540 each form a tube of axis L and are in sliding contact with the surface of the internal space 16. The holding means 54 and 540 each comprise a disc-shaped base pierced by a hole which is adapted to grip the contact means 52 and to hold it in the axis X.

The bases 51, 510 each include a cylindrical cavity 56, 560 of axis L opening onto the internal space 16. A cavity 56, 560 respectively, is adapted to receive a flexible means 58, 580 respectively, with an axis parallel to the direction L which rests on the base of the said cavity 56, 560 respectively. In the embodiment shown in FIG. 2 the flexible means 58, 580 respectively, is a spring.

The movable element 54, 540 respectively, is capable of bearing on the spring 58, 580 respectively, and also on the internal surface of the bases 51, 510 respectively.

In the first state of the switching device D, shown in solid lines in FIG. 2, the spring 58 is compressed and is totally engaged in the cavity 56.

The spring 580 is relaxed and extends over the entire length of the cavity 560 and in the internal space 16.

We will now describe the drive means 60 of the contact means 52. The drive means 60 is adapted to displace the contact means 52 in such a way as to effect the switching between the first state and the second state of the switching device D.

The drive means 60 of the contact means 52 is integrated within the insulator 14 and more precisely in the casing 15.

The drive means 60 comprises two coils 61, 610 installed in the casing 15. The two cylindrical coils 61, 610 surround the cylinder forming the internal space 16 and are each disposed at an end of the internal space 16 in such a way that they respectively surround the tubular structures 23 and 230 of the terminals I₁ and I₂ respectively.

The coils 61, 610 are electrically connected to a supply means of the said coils (not shown) by means of supply lines 63, 630 which run in the casing 15 and exit from the insulator 15 by passing through an intermediate insulator 15c provided between the two rows of fins 15a and 15b. The supply means is for example a current or voltage source.

Permanent magnets 62, 620 respectively, are distributed at the end of the insulator 14 in the bases 51, 510 respectively.

The actuating device of the switching device is disposed outside the device and it comprises the said current source as well as a control means included in the on-board computer.

Such an actuating device has the advantage of being compact. Moreover, the described driving device has the advantage of being integrated into the insulator of the switch and of representing a fixed and small volume.

As a variant, the drive means 60 is accommodated outside the insulator 14. This drive means is for example of the electromagnet type as described above or a pneumatic actuator.

We will now describe how the switching is carried out between the first state and the second state of the switching device according to the invention.

When the contact means 52 is in the first state in which it establishes the electrical connection between the common terminal Co and the first individual terminal I1 the coils 61 and 610 are not supplied with current.

When the on-board computer controls the configuration of the circuit and the switching is necessary, the computer controls the supply of current to the coils 61, 610, with a current circulating in a first direction.

The current circulation direction in the coils 61, 610 is adapted so that the longitudinal component of the magnetic field created in the coil 61 surrounding the first individual terminal I₁ is opposed to the longitudinal component of the magnetic field created by the permanent magnets 62 on the movable element 54.

When the sum of the longitudinal components of the magnetic fields created by the coil 61 on the one hand and the permanent magnets 62 on the other hand is less than the longitudinal component of the force exerted by the flexible means 58 on the movable element 54, the movable element 54 is displaced longitudinally in the direction of the base 510. Thus the contact means 52 is driven longitudinally in the direction of the second individual terminal I₂ as far as the second position shown in dotted lines in FIG. 2.

The current circulating in the coil 610 creates a magnetic field which is sufficient to complete the compression of the spring 580 and to adhere the movable element 540 magnetically to the permanent magnets 620.

The supply of current to the coils 61, 610 is then interrupted, and the contact means 52 remains in its second position in which it is held.

The movable element 540 is held against the wall 510 due to the longitudinal component of the permanent magnetic field created by the permanent magnets 620.

Thus the electrical connection between the common terminal Co and the second individual terminal I₂ is established in a durable manner.

When the current is established in the contrary direction in the coils 61, 610 the magnetic field created by the permanent magnets 62, 620. The contact means 52 is then displaced towards the first individual terminal I₁. The contact means 52 enters in translation according to the axis X in such a way as to come into its first position shown in solid lines in FIG. 2, and to establish the connection between the common terminal Co and the first individual terminal I₁.

Upon reading the foregoing it will be understood that the holding and displacement device or movable element 54 carries out a function of holding the contact means 52 and a function of displacement of the contact means, this latter function being achieved with the flexible means 58, 580. The person skilled in the art could easily conceive a driving device in which the functions of holding and of displacement would be separated, that is to say implemented by different devices.

Such a switching device D, equipped with such a drive means 60 of the electromagnetic type has the advantage of having a shorter switching time than a switching device according to the prior art. A switching device according to the invention has a switching time of less than a second.

Advantageously, the internal cavity 16 formed within the insulator 14 is sealed and filled with a dielectric fluid, for example of the dielectric gas type such as sulphur hexafluoride, dry air or a vacuum.

The use of a dielectric fluid of which the dielectric properties are greater than air makes it possible to significantly reduce the distance between each of the individual terminals I₁ and I₂ and the end of the contact means 52 which is adjacent thereto, when the said contact means 52 is electrically connected to the opposing individual terminal. The distance between each of the individual terminals I₁ and I₂ and the end of the contact means 52 which is adjacent thereto, that is to say the insulation distance, could be between 50 and 100 mm.

This embodiment also makes it possible to reduce the switching time of the switch since the distance to be traveled by the contact means 52 in order to effect the switching is less than in air.

Moreover, the reduced distance between the individual terminals of the switching device within the sealed cavity 16 makes it possible to limit the electromagnetic energy necessary for the switching. Indeed, the distance covered by the contact means 52 between the first state and the second state is reduced, which requires less electromagnetic energy in order to displace the contact means. This also makes it possible to use coils 61, 610 of limited size.

An HOC switch is a switching device according to the invention, as has been described above, which is installed on a vehicle 11 and of which the three terminals—power H, earth O and roof C—are connected to supply circuits, that is to say respectively the DC power line 8, an earth line 10 and a collection line 7.

The collection line 7 is called the roof line when it extends over the roof of a vehicle. A collection line 7 can also extend partially in other parts of the vehicle, for example in the interior of the vehicle.

In a switch of the HOC type, the DC power terminal H corresponds to the common terminal Co, the collection terminal C and the earth terminal O correspond respectively, indiscriminately, to one or the other of the first individual terminal I₁or of the second individual terminal I₂.

The DC power terminal H is connected to the DC power line 8 by means of the junction bar JH which then corresponds to the common junction bar JCo.

The earth terminal O which corresponds to the first individual terminal I₁ (or to the second individual terminal I₂) is connected to an earth line 10 by means of a junction bar JO corresponding to the first junction bar JI₁ (or to the second junction bar JI₂).

The collection terminal C which then corresponds to the second individual terminal I₂ (or to the first individual terminal I₁) is then connected to the collection line 7 by means of a junction bar JC corresponding to the second junction bar JI₂ (or to the first junction bar JI₁).

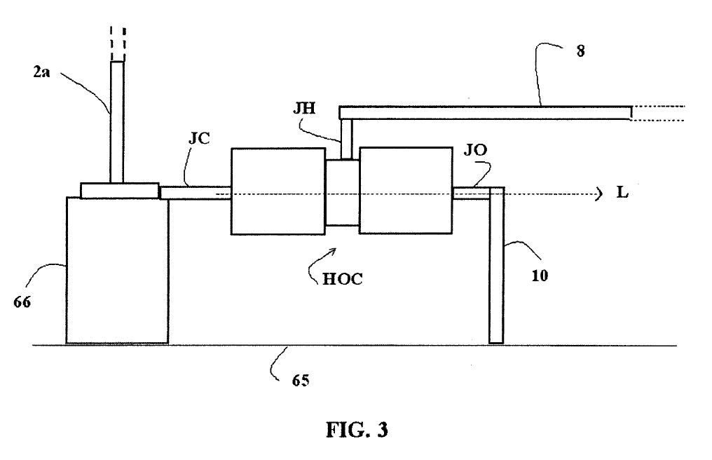

FIG. 3 shows, in a side view, an example of integration of a switch HOC on the roof of a vehicle.

The switching device D of the HOC type is disposed on the vehicle on the roof in such a way that its longitudinal axis X is substantially horizontal, that is to say parallel to its support, in this case the roof 65.

In another embodiment the switching device D disposed on the vehicle is disposed in the interior of a compartment of which the lower face constitutes a support 65 connected to earth and extending substantially horizontally.

The junction bar JO of the earth terminal O is connected to the earth line by means of a rigid bar, or a flexible connection constituting the earth line 10 and extending between the junction bar JO and the roof 65.

The junction bar JC of the collection terminal C is connected directly to the high-voltage pantograph 2a which is disposed on the roof line 7. The high-voltage pantograph 2a is insulated from the roof 65 by means of an insulator 66.

The connections between the junction bar JH and the power line 8 and also between the junction bar JC and the high-voltage pantograph 2a are rigid connections, in such a way that the longitudinal axis X of the switch extends substantially horizontally.

The junction bar JH of the common power terminal is connected to the DC power line 8 constituted for example by a metal bar extending along the roof 65 and insulated from the roof 65 by means of insulators (not shown).

The switching device according to the present invention therefore offers the advantage that it does not require the provision of specific insulators adapted to insulate the individual or common terminals of the roof or of the support on which it rests.

In another embodiment (not shown) the junction bar JC is connected to a metal bar constituting the roof line 7 which is electrically insulated from the roof by means of insulators. The roof line 7 then connects the switching device D, of the HOC type, to the pantograph 2a.

Thus the switching device D according to the invention can be easily integrated, on the roof or in the vehicle, into the power collection circuit and is compact. Indeed, it is not necessary to provide specific insulators for the insulation of each of the terminals of the circuit since the junction bars of the circuit which are not connected to earth are directly connected to connection points which are insulated with respect to earth.

In another embodiment (not shown) the switching device D, of the HOC type, is disposed on the vehicle in such a way that its longitudinal axis X is substantially vertical, that is to say perpendicular to the support 65.

The junction bar JO of the earth terminal O is connected to earth by means of a mechanical connection on the roof 65 of the vehicle 1. The junction bar JC of the collection terminal C is connected directly to the high-voltage pantograph 2a which is disposed on the roof line 7. The connection between the junction bar JC and the high-voltage pantograph 2a is a rigid connection.

The junction bar JH of the common power terminal is connected to the DC power line 8 consisting for example of a metal bar which extends along the roof 65 and is insulated from the roof 65 by means of insulators (not shown).

A disconnecting switch of the PbT type is a switching device as described previously, of which only two terminals T and Pb are connected to the current collection circuit, that is to say to the collection line 7 and to a collection means 2b respectively.

In a disconnecting switch of the PbT type the common terminal Co is indiscriminately the terminal Pb or the terminal T. In the case where the common terminal is the terminal T, the terminal Pb is indiscriminately one or the other of the first individual terminal I₁ or the second individual terminal I₂. In the case where the common terminal is the terminal Pb, the terminal T is indiscriminately one or the other of the first individual terminal I₁ or the second individual terminal I₂.

The terminal Pb is connected to the pantograph 2b by the junction bar JPb and the terminal T is connected to the power line by means of a junction bar JT.

This description also applies to a switching device of the disconnecting switch type TR. In a disconnecting switch of the TR type, the common terminal Co is indiscriminately the terminal R or the terminal T. In the case where the common terminal is the terminal T, the terminal R is indiscriminately one or the other of the first individual terminal I₁ or the second individual terminal I₂. In the case where the common terminal is the terminal R, the terminal T is indiscriminately one or the other of the first individual terminal I₁ or the second individual terminal I₂.

The terminal T is connected to the collection line 7 by means of the junction bar JT and the terminal R is connected to the inter-vehicle line 5 by means of a junction bar JR.

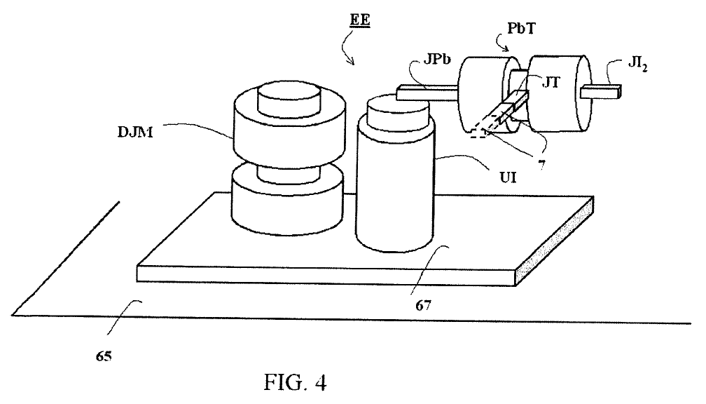

FIG. 4 shows an embodiment for the installation of the disconnecting switch PbT on the roof of a vehicle.

The collection terminal T, in this case the roof terminal T of the disconnecting switch PbT, is connected to the roof line 7 directly between the voltage measuring device 6 and the pantograph 2a.

The junction bar JPb is connected directly to a voltage current measuring device IU which integrates, within one single insulator, the current measuring device 4 and the voltage measuring device 6. The terminal T is connected to the roof line 7, consisting of an electrically conductive cable.

An electrical unit EE comprises, disposed on one single individual support 67, a device for measuring current and voltage UI and the monophase circuit breaker DJM. The electrical unit EE also includes the disconnecting switch PbT.

The electrical unit EE is disposed on a support 65, in this case on the roof, and the connections to the other electrical units of the vehicle are produced. In particular, the junction bar JT is directly connected to the roof line 7.

The roof line 7 is connected to the pantograph 2b (not shown in FIG. 4).

The integration of a switching device of the disconnecting switch PbT type into an electrical unit EE makes it possible to ensure easy installation of the said switching device PbT in a restricted space. Moreover, such an electrical unit EE constitutes a multi-function unit which integrates several electrical functions and which can be sold as it is.

An electrical unit EE comprising on a single support a voltage current measuring device UI and a switching device PbT has the advantage that it constitutes an autonomous switching assembly, because it comprises the current and voltage measuring means which are necessary for the detection of the current and of the voltage of the catenary line as well as a switching device capable of being switched by an on-board computer in order to configure a part of the supply circuit of the vehicle.

In a variant, the electrical unit EE combines, in addition to the monophase circuit breaker DJM and the current and voltage measuring device UI, the earthing switch HOM as well as a lightning arrester 9, in an integrated manner on a single individual support 67.

In a variant, the current and voltage measuring device UI comprises an insulator which includes the voltage measuring device 6 and an insulator including the current measuring device 4, these two insulators being integrated on the individual support 67.

1. Switching device (D) disposed on an electrically powered vehicle, capable of switching, by rectilinear displacement of a contact means (52) by means of a drive means (60), indiscriminately in the two directions, between a first state in which said contact means (52) establishes an electrical connection between a first individual terminal (I₁) and a common terminal (Co) and a second state in which said contact means (52) establishes an electrical connection between a second individual terminal (12) and said common terminal (Co), said switching device (D) being characterised in that said individual terminals (I₁, I₂), said common terminal (Co) and said contact means (52) are disposed within one single insulator (14).

2. Switching device (D) as claimed in claim 1, wherein said drive means is disposed within said insulator (14).

3. Switching device (D) as claimed in claim 1, wherein:
the insulator (14) comprises a casing (15) defining an internal space (16) extending in a longitudinal direction (L);
the first individual terminal (I₁), the second individual terminal (I₂) and the contact means (52) are spaced longitudinally in the longitudinal direction (L);
said contact means (52) extends in the longitudinal direction (L) between the first individual terminal (I₁) and the second individual terminal (I₂);
said contact means (52) is connected to said common terminal (Co) by a connection means (50).

4. Switching device (D) as claimed claim 1, wherein during the switching the contact means (52) undergoes a translatory movement in the longitudinal direction (L) in such a way as to be displaced, indiscriminately in the two directions, from a first position in which it establishes the electrical connection to the first individual terminal (I₁) towards a second position in which it establishes the electrical connection to the second individual terminal (I₂).

5. Switching device (D) as claimed in claim 1, wherein the internal space (16) is sealed and is filled with a dielectric fluid.

6. Switching device (D) as claimed in claim 1, wherein the drive means (60) comprises:
at least two coils (61, 610) integrated in the casing (15) and each surrounding an individual terminal (I₁, I₂);
permanent magnets (64, 640) distributed over the ends of the casing (15);
a means for displacement (58, 580, 53) of the contact means (52);
the coils (61,610) being supplied by means of a supply means disposed outside the insulator (14).

7. Switching device (D) as claimed in claim 1, wherein said device (D) is disposed on an electrically powered vehicle, on a support (65), in such a way that the longitudinal direction (L) is substantially vertical.

8. Switching device (D) as claimed in claim 1, wherein said device (D) is disposed on a railway vehicle, on a support (65), in such a way that the longitudinal direction (L) is substantially horizontal.

9. Switching device (D) as claimed in claim 1, wherein said switching device (D) is of the switch type, wherein the first individual terminal (I₁), the second individual terminal (I₂) as well as the common terminal (Co) are each connected to a supply circuit.

10. Switching device (D) as claimed in claim 9, in which:
the first individual terminal (I₁) is an earth terminal (O) and is connected electrically to an earth line (10);
the second individual terminal (I₂) is a collection terminal (C) and is connected electrically to a collection line (7);
the common terminal (Co) is a power terminal (H) and is connected to a DC power line (8).

11. Switching device (D) as claimed in claim 1, wherein said switching device (D) is of the disconnecting switch type, the common terminal (Co) as well as only one of the two individual terminals (I₁) and (I₂) each being connected to a supply circuit.

12. Switching device (D) as claimed in claim 9, in which:
in a first variant, the common terminal (Co) is a terminal which is either a terminal (T) connected to a collection line (7), one of the individual terminals (I₁, I₂) then being a terminal (Pb) connected to a current collection means (2a), or a terminal (Pb) connected to a collection means (2a), one of the individual terminals (I₁, I₂) then being a terminal (Pb) connected to a collection line (7);
in a second variant, the common terminal (Co) is a terminal (T) which is either a terminal (T) connected to a collection line (7), one of the individual terminals (I₁, I₂) then being a terminal (R) connected to an inter-vehicle line (5), or a terminal (R) connected to a inter-vehicle line (5), one of the individual terminals (I₁, I₂) then being a terminal (T) connected to a collection line (7).

13. Switching device (D) as claimed in claim 1, wherein the terminals (I₁, I₂, Cₒ) of the switching device which are connected to a supply line, with the exception of the terminal(s) which are connected to an earth line, are connected to connection points which are insulated from the support (65).

14. Method of implementing a switching device (D), said switching device (D) being as claimed in claim 1, for switching between said first state and said second state, wherein it comprises:
a step of supplying current to the coils (61, 610) in a first current circulation direction in such a way as to drive the contact means (52) in the direction of the second individual terminal (I₂); and
a step of interruption of the supply of current to the coils (61, 610) when the contact means (52) establishes the electrical connection to the second terminal (I₂) in such a way as to keep the contact means in position by means of the permanent magnets (64, 640).

15. Method of implementing a switching device (D), said device being as claimed in claim 1, for producing the switching between said second state and said first state, wherein it comprises:
a step of supplying current to the coils (61,610) in a second current circulation direction in such a way as to drive the contact means (52) in the direction of the first individual terminal (I₁);
a step of interruption of the current supply to the coils (61, 610) when the contact means (52) establishes the electrical connection to the first terminal (I₁) in such a way as to keep the contact means in position by means of the permanent magnets (64, 640).

16. Method of implementing a switching device (D) as claimed in claim 14, wherein during the supply step the contact means (52) is driven from the first individual terminal (I₁) towards the second individual terminal (I₂) when the longitudinal component of the magnetic field created by the current circulating in the coil (61) is opposed to the longitudinal component of the magnetic field created by the permanent magnets (62), said contact means (52) then being driven towards the second individual terminal (I₂) by means of a displacement device (58, 580, 53).

17. Electrical unit (EE), wherein it includes in an integrated manner on a single individual support (67):
a voltage current measuring device (UI);
a switching device (D) as claimed in claim 10.

18. Electrical unit (EE) as claimed in claim 9, wherein it further includes, in an integrated manner on said single individual support (67), at least one unit selected from amongst:
an earthing switch (HOM);
a lightning arrester (9);
a monophase circuit breaker (DJM).
